(19) United States
(12) Patent Application Publication
(10) Pub. No.: US 2021/0397602 A1
(43) Pub. Date: Dec. 23, 2021

(54) SYSTEMS AND METHODS FOR ANALYZING ELECTRONIC DATA TO DETERMINE FAULTS IN A TRANSIT SYSTEM

(71) Applicant: Capital One Services, LLC, McLean, VA (US)

(72) Inventors: Abdelkader BENKREIRA, New York, NY (US); Joshua EDWARDS, Philadelphia, PA (US); Michael MOSSOBA, Arlington, VA (US)

(73) Assignee: Capital One Services, LLC, McLean, VA (US)

(21) Appl. No.: 16/908,158

(22) Filed: Jun. 22, 2020

(51) Int. Cl. G06F 16/23; G06N 20/00; G06N 5/04; H04L 29/08

(52) U.S. Cl. CPC G06F 16/2379; G06N 20/00; G06N 5/04; H04L 67/18; H04L 67/20; H04L 67/26; H04L 67/22

(57) ABSTRACT

A computer-implemented method for analyzing electronic data associated with a public transit system may include determining a location of a target public transit stop of the public transit system; determining a location of a first user; identifying population location data relevant to the target public transit stop; determining activity data associated with the target public transit stop based on a quantity of users entering and leaving the target public transit stop within a given time period, by processing data including the identified population location data using a trained machine learning model; and providing, to the first user, a notification based on the determined activity data and the location of the first user.

### TECHNICAL FIELD

Various embodiments of the present disclosure relate generally to analyzing electronic data associated with a public transit system.

### BACKGROUND

Commuters relying on public transit systems are often faced with the inconvenience of delays, maintenance issues, and route closures. Public transit systems may have their own information on schedule delays and changes. However, commuters may have difficulty assessing what information is pertinent to their specific transit route and location, since transit data is constantly changing and affected by of-the-moment circumstances.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for analyzing electronic data associated with a public transit system.

In one embodiment, a computer-implemented method for analyzing electronic data associated with a public transit system may comprise, determining a location of a target public transit stop of the public transit system; determining a location of a first user; identifying population location data relevant to the target public transit stop; determining activity data associated with the target public transit stop based on a quantity of users entering and leaving the target public transit stop within a given time period, by processing data including the identified population location data using a trained machine learning model; and providing, to the first user, a notification based on the determined activity data and the location of the first user.

In another embodiment, a computer system for analyzing electronic data associated with a public transit system may comprise at least one memory storing instructions; and at least one processor configured to execute the instructions to perform operations comprising: determining a location of a target public transit stop of the public transit system; determining a location of a first user; retrieving transactional data indicating user transactions at the target public transit stop, the transactional data satisfying one or more criteria for identifying population location data relevant to the target public transit stop; determining activity data associated with the target public transit stop based on a quantity of user entering and leaving the target public transit stop within a given time period, by processing data including the retrieved transactional data using a trained machine learning model; and providing to the first user over a computer network, a notification based on the determined activity data and the location of the first user.

In another example, a computer system for analyzing electronic data associated with a public transit system may comprise at least one memory storing instructions; and at least one processor configured to execute the instructions to perform operations including: determining a location of a target public transit stop; receiving, from a third-party over a computer network, information indicating a disruption at the target public transit stop; retrieving transactional data indicating user transactions of a first user at the target public transit stop; identifying a location of the first user based on the transactional data of the first user at the target public transit stop; determining activity data of the first user entering and/or leaving the target public transit stop within a given time period, by processing data including the retrieved transactional data using a trained machine learning model; and providing, to the first user over a computer network, a notification based on the determined activity data and the location of the first user.

According to additional aspects of the disclosure, a non-transitory computer-readable medium stores instructions that, when executed by one or more processors, cause the one or more processors to perform the aforementioned computer-implemented method or the operations that the aforementioned computer systems are configured to perform.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of analyzing data associated with a public transit system, according to one or more embodiments.

FIG. 3 depicts a flowchart of an exemplary method of analyzing data associated with a public transit system, according to one or more embodiments.

FIG. 4 depicts a flowchart of an exemplary method of analyzing data associated with a public transit system, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as location data or transactional data may be used to determine activity data at a target public transit stop. This determination of activity data may be used to generate one or more recommendations based on the determined activity data, relative to the location data or transactional data.

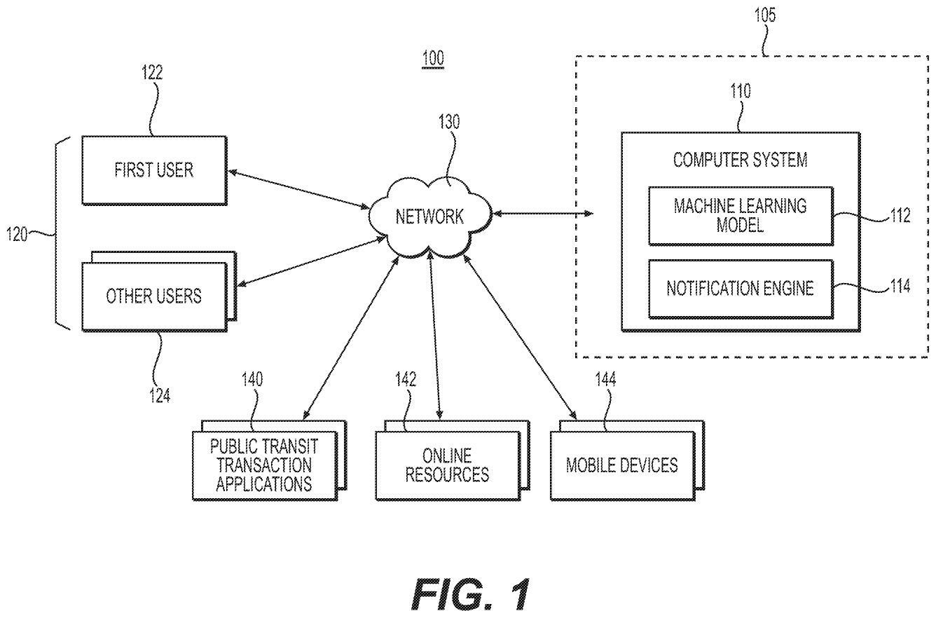

FIG. 1 is a diagram depicting an example of a system environment 100 according to one or more embodiments of the present disclosure. The system environment 100 may include at least one computer system 110, users 120, public transit transaction applications 140, online resources 142, and mobile devices 144. These components may be connected to one another by a network 130.

The computer system 110 may have one or more processors configured to perform methods described in this disclosure. User 122 may be referred to as a “first user,” which may be used to refer to a user whose location is determined and who then receives a notification as evaluated by the computer system 110. The computer system 110 may comprise at least one machine learning model 112 and a notification engine 114, which may each be software components stored in the computer system 110. The computer system 110 may be configured to utilize the machine learning model 112 and/or notification engine 114 when performing various methods described in this disclosure. Machine learning model 112 may be a plurality of machine learning models.

In some examples, the computer system 110 may have a cloud computing platform with scalable resources for computation and/or data storage, and may run one or more applications on the cloud computing platform to perform various computer-implemented methods described in this disclosure.

Computer system 110 may be configured to receive data from other components (e.g., users 120, public transit transaction applications 140, online resources 142, and/or mobile devices 144) of the system environment 100 through network 130. Computer system 110 may further be configured to utilize the received data by inputting the received data into the machine learning model 112 to produce a result. Information indicating the result may be transmitted to first user 122 over the network 130. In some examples, the computer system 110 may be referred to as a server system that provides a service including providing the information indicating the result to first user 122. Additionally, a computing device of the first user 122 may operate a client program, also referred to as a user application, used to communicate with the computer system 110. This user application may be used to provide information to the computer system 110 and to receive information from the computer system 110. In some examples, the user application may be a mobile application that is run on a mobile device (e.g., mobile device 144) operated by first user 122.

Users 120 may each be an entity that use a public transit system and/or a target public transit stop. In this disclosure, first user 122 may have a different physical location than other users 124, also referred to herein as “customers.”

Network 130 may be any suitable network or combination of networks and may support any appropriate protocol suitable for communication of data to and from the computer system 110 and between various other components in the system environment 100. Network 130 may include a public network (e.g., the internet), a private network (e.g., a network within an organization), or a combination of public and/or private networks.

Public transit transaction applications 140 may provide users with the ability to provide payment throughout a public transit system, wherein the applications may have the ability to accept electronic payments, such as payments using credit cards and debit cards. Therefore, public transit transaction applications 140 may collect and store transactional data pertaining to user transactions.

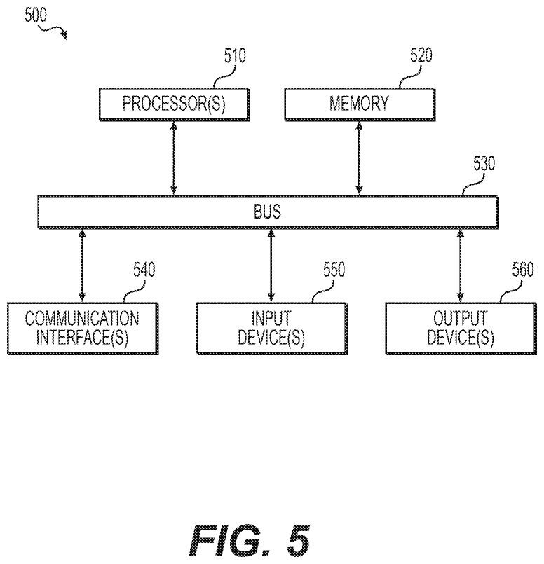

The users 120 and public transit transaction applications 140 may each include one or more computer systems configured to gather, process, transmit, and/or receive data. In general, whenever any of the users 120 and public transit transaction applications 140 is described as performing an operation of gathering, processing, transmitting, or receiving data, it is understood that such operation may be performed by a computer system thereof. In general, a computer system may include one or more computing devices, as described in connection with FIG. 5, below. Online resources 142 may include other computer systems, such as web servers, that are accessible by computer system 110. Such resources may provide information, such as a schedule of maintenance, a schedule of delays, or a schedule of holidays.

Mobile devices 144 may each be a computer system. Examples of mobile devices 144 may include smartphones, wearable computing devices, tablet computers, and vehicle computer systems. Mobile devices 144 may be capable of transmitting information indicating a current location of the device. For example, mobile devices 144 may have an application configured to transmit data indicating a current location of the mobile device 144 to computer system 110. The mobile devices 144 may determine its location based on data obtained by a GPS included in the mobile device 144 and/or other location estimation techniques.

Computer system 110 may be part of entity 105, which may be any type of company, organization, or institution. In some examples, the entity 105 may be a financial services provider. In such examples, the computer system 110 may have access to data pertaining to consumer transactions through a private network within the entity 105. For example if the entity 105 is a card issuer, entity 105 may collect and store transactions involving a credit card or debit card issued by the entity 105. In such examples, the computer system 110 may still receive transactional data from other public transit transaction applications 140.

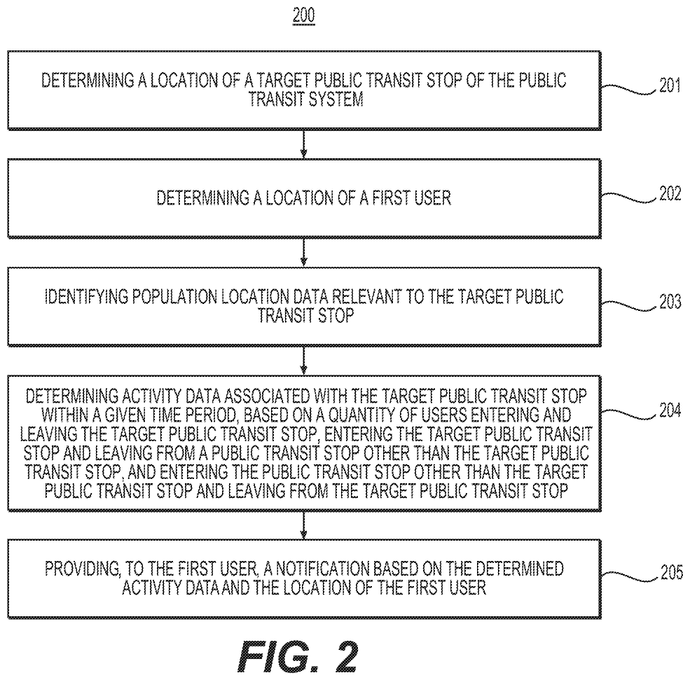

FIG. 2 is a flowchart illustrating a method for analyzing data associated with a public transit system, according to one or more embodiments of the present disclosure. The method may be performed by computer system 110. For purposes of illustration, user 122 is used as an example of the first user, and entity 105, operating the computer system 110, is assumed to be a financial services provider.

Step 201 may include determining a location of a target public transit stop of the public transit system. The target public transit stop may be determined from data obtained by a GPS included in a mobile device of the first user. In other examples, the target public transit stop may be determined from data obtained by a GPS included in mobile devices of the other users 124.

Step 202 may include determining a location of a first user. The location of a first user may be determined from data obtained by a GPS included in a mobile device of the first user. In other examples, the location of a first user may be determined by receiving information specifying the first user's location, from the first user 122. Such information may be communicated to the computer system 110 using, for example, a mobile device of the first user.

Step 203 may include identifying population location data relevant to the target public transit stop. Such data may be obtained by a GPS included in mobile devices of the other users 124. Such information may be communicated to the computer system 110 using, for example, a mobile device of the other users 124. Step 203 may further include identifying one or more other users having at least one characteristic in common with the first user, such as one of or a combination of: (a) geographical area; and (b) public transit route. A geographical area may be a specific geographical location (e.g., an address or coordinate position), or a region, area, city, neighborhood, or locality in which the first user and/or other users is located.

Step 204 may include determining activity data associated with the target public transit stop based on a quantity of users entering and leaving the target public transit stop within a given time period, by processing data including the identified population location data using a trained machine learning model (e.g., machine learning model 112). The determined activity may show various activity occurring at the target public transit stop, for example, closures or delays, unscheduled maintenance or construction, single-tracking, etc.

The machine learning model 112 may be a regression-based model that accepts the data identified in step 203 as input data. The machine learning model 112 may be of any suitable form, and may include, for example, a neural network or deep neural network. The machine learning model 112 may compute the activity as a function of the given time period, the quantity of users entering and leaving the target public transit stop, and one or more variables indicated in the input data. This function may be learned by training the machine learning model 112 with training sets. In some examples, the given time period and quantity of customers may be automatically selected by the computer system 110 or machine learning model 112.

The machine learning model 112 may be trained (prior to its usage in step 203) by supervised, unsupervised, or semi-supervised learning using training sets comprising data of types similar to the type of data used as the model input. For example, the training set used to train the model 112 may include any combination of the following: population location data relevant to the target public transit stop; data indicating transactions of the first user 122 at the target public transit stop; data indicating a pattern of public transportation of the first user 122; data indicating transactions of the other users 124 at the target public transit stops; and/or data indicating other user activity. The quantity or value of user transactions at a target public transit stop for various periods of time may be expressly indicated in the training set or, alternatively, computable based on the data indicating population location data at a target public transit stop or other data in the training set.

Accordingly, the machine learning model 112 may be trained to map input variables to a quantity or value of user transactions for a target public transit stop. That is, the machine learning model 112 may be trained to determine a quantity or value of user transactions for the target public transit stop as a function of various input variables. Such input variables may describe, for example, locations of a first user, locations of other users, user transactions at the target public transit stop (e.g., the number of times a user enters and leaves the target public transit stop). The quantity or value of user transactions determined by the machine learning model 112 may be specific to a period of time, which may be used as an additional input variable.

For example, the machine learning model 112 may be trained to determine if a certain threshold of users are entering and leaving the same public transit stop. For example, if at least 25% of users are entering and leaving from the same public transit stop within a pre-determined period of time, this may indicate a congested or busy transit stop. If at least 50% of users are entering and leaving from the same public transit stop within a pre-determined period of time, this may indicate a closed transit stop. Depending on the determined activity data, the machine learning model 112 may be trained to provide a notification based on such determined activity data, as will be discussed below in step 205. Additionally, the machine learning model 112 may be trained on data indicating a pattern of public transportation of the first user 122, based on locations of the first user at certain times for a pre-determined period of days, weeks, and/or months. Based on this information, the machine learning model 112 may be trained to recognize when the first user is likely to go to a target public transit stop. If the target public transit stop is busy or closed, the machine learning model may provide, to the first user, a notification that there is an issue with the target public transit stop and/or an alternative stop the first user may take.

Step 204 may further include processing data collected from a third-party application, wherein the third-party application may be public transit transaction applications 140, online resources 142, or mobile devices 144. The data may include at least one or a combination of: (a) a schedule of maintenance; (b) a schedule of delays; (c) a schedule of holidays; or (d) special events. This data may also be inputted into the machine learning model 112.

Step 205 may include providing, to the first user, a notification based on the determined activity associated with the target public transit stop and the location of the first user 122. This notification may indicate, for example, the activity associated with the target public transit stop determined in step 204, at least one impact causing delays at the target public transit stop, or a recommendation as to whether the transit route for the first user 122 should be modified based on the activity. The recommendation may identify at least one alternative public transit stop. This information may be presented to the first user 122 in any suitable form, such as an email, a text message, a push notification, and/or content on a web page. The information may also be presented in the user application discussed above.

In some examples, step 205 may occur in response to a notification trigger. For example, the notification engine 114 may detect whether a notification trigger has occurred, and transmit the information to the first user 122 upon detecting that the notification trigger has occurred. The notification trigger may be, for example, a quantity of users entering and leaving the target public transit stop within a given time or a significant change in the activity determined in step 204 from a previously determined activity.

Any of the aforementioned data pertaining to individual customers or users may be anonymized, such that the information transmitted to the first user 122 is not associable with personal identities. Additionally, the computer system 110 may be configured to perform the method of FIG. 2 only when the input data is of the extent that anonymity of individual customers or users may be protected. Additionally, step 204 may be repeated for a plurality of periods of time within the duration that the first user's location is near or at the location of the target public transit stop.

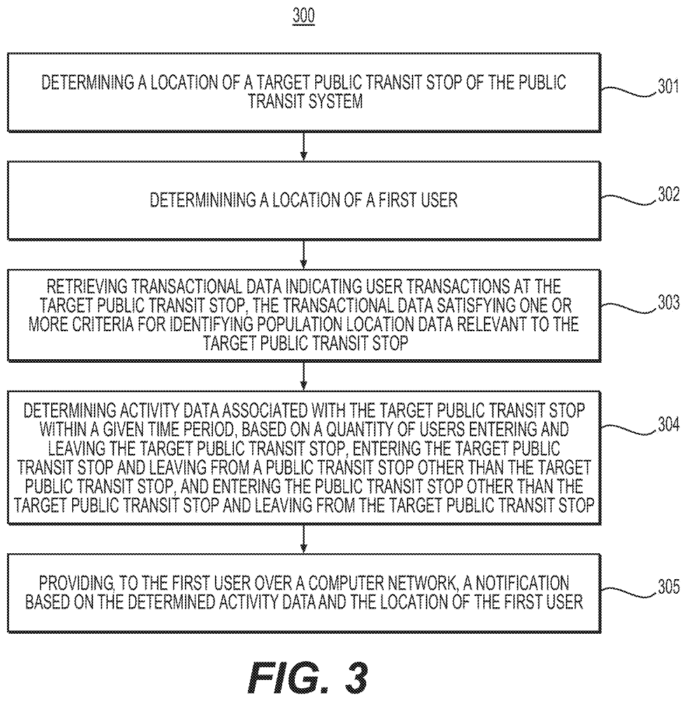

FIG. 3 is a flowchart illustrating a method for analyzing electronic data associated with a public transit system. The method may include determining a location of a target public transit stop of the public transit system (step 301); determining a location of a first user (step 302); retrieving transactional data indicating user transactions at the target public transit stop, the transactional data satisfying one or more criteria for identifying population location data relevant to the target public transit stop (step 303); determining activity data associated with the target public transit stop based on a quantity of users entering and leaving the target public transit stop within a given time period, by processing data including the retrieved transactional data using a trained machine learning model (step 304); and sending, to the first user over a computer network, a notification based on the determined activity and the location of the first user (step 305). Steps 301, 302, and 305 may respectively correspond to steps 201, 202, and 205 of FIG. 2, and may include any of the features discussed for steps 201, 202, and 205, above.

In step 303, transactional data indicating user transactions at the target public stop may be obtained from the public transit transaction applications 140 as discussed above. Transactional data, for the first user 122 and the other users 124, may include transactional details, such as the amount of the transaction and the timestamp of the transaction, so as to permit an assessment of the frequency and/or number of transactions during a certain period of time. In step 304, the transactional data obtained in step 303 is included in the determination of the activity associated with the target public transit stop based on a quantity of customers entering and leaving the target public transit stop within a given time period. In step 305, the notification may be any of the ones discussed above, i.e., delays or alternate routes. The notification may also be based on the retrieved transactional data at the target public transit stop. For example, if the first user scans into and scans out of the same station within a pre-determined period of time, i.e., 5 minutes, the machine learning model may be trained to recognize that there was an issue with the target public transit stop and to issue a notification to the first user, in the form of a monetary refund. To prevent users from repeatedly scanning in and scanning out of transit stops to receive refunds, the machine learning model may be trained to only allow a certain number of refunds for a user during a pre-determined period of time. In other public transit systems, for example when a user only has to scan into the transit stop, the machine learning model may be trained to recognize if a certain threshold of users are entering and leaving the same public transit stop within a pre-determined period of time, as discussed above. If this threshold is met, a notification, for example in the form of a monetary refund, may be issued to the first user.

It should be appreciated that the monetary refund may be automatically provided via electronic payment, such as, for example, to a credit card and/or debit card of the user. In this instance, the notification received by the user (e.g., via mobile device 144) may notify the user of various details regarding the refund, such as an amount, time, date, and/or basis for the refund payment. The refund may be processed for return to the credit card and/or debit card of the user via public transit transaction application 140 stored on mobile device 144.

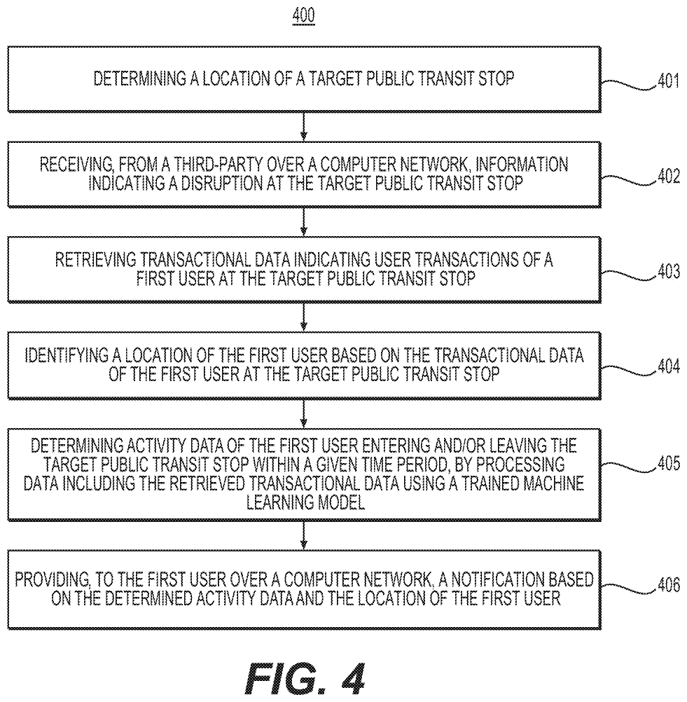

FIG. 4 is a flowchart illustrating a method for analyzing electronic data associated with a public transit system. The method may include determining a location of a target public transit stop (401); receiving, from a third-party over a computer network, information indicating a disruption at the target public transit stop (step 402); retrieving transactional data indicating user transactions of a first user at the target public transit stop (step 403); identifying a location of the first user based on the transactional data of the first user at the target public transit stop (step 404); determining an activity of the first user entering and/or leaving the target public transit stop within a given time period, by processing data including the retrieved transactional data using a trained machine learning model (step 405); and sending, to the first user over a computer network, a notification based on the determined activity and the location of the first user (step 406). Steps 401 and 406 respectively correspond to steps 201 and 205 of FIG. 2, and may include any of the features discussed for steps 201 and 205, above.

In step 402, the third-party may be the public transit applications 140 or online resources 142, as discussed above. The disruption at the target public transit stop may be, for example, closures or delays, unscheduled maintenance or construction, single-tracking, etc.

In step 403, the transactional data of the first user 122 at the target public transit stop may include transactional details, such as the amount of the transaction and the timestamp of the transaction, so as to permit an assessment of the frequency and/or number of transactions during a certain period of time. The retrieved transactional data allows for identification of the location of the first user 122, in step 404, and is used to determine an activity of the first user entering and/or leaving the target public transit stop within a given time period, in step 405. In step 405, the machine learning model 112 may determine an activity of the first user entering and/or leaving the target public transit stop within a given time period, by processing the retrieved transactional data.

In general, any process discussed in this disclosure that is understood to be computer-implementable, such as the processes illustrated in FIGS. 2-4, may be performed by one or more processors of a computer system, such as computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as computer system 110, may include one or more computing devices. If the one or more processors of the computer system 110 are implemented as a plurality of processors, the plurality of processors may be included in a single computing device or distributed among a plurality of computing devices. If a computer system 110 comprises a plurality of computing devices, the memory of the computer system 110 may include the respective memory of each computing device of the plurality of computing devices.

FIG. 5 illustrates an example of a computing device 500 of a computer system, such as computer system 110. The computing device 500 may include processor(s) 510 (e.g., CPU, GPU, or other such processing unit(s)), a memory 520, and communication interface(s) 540 (e.g., a network interface) to communicate with other devices. Memory 520 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 520. The computing device 500 may, in some embodiments, further include input device(s) 550 (e.g., a keyboard, mouse, or touchscreen) and output device(s) 560 (e.g., a display, printer). The aforementioned elements of the computing device 500 may be connected to one another through a bus 530, which represents one or more busses. In some embodiments, the processor(s) 510 of the computing device 500 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for analyzing electronic data associated with a public transit system, the method comprising:
determining a location of a target public transit stop of the public transit system;
determining a location of a first user;
identifying population location data relevant to the target public transit stop;
determining activity data associated with the target public transit stop based on a quantity of users entering and leaving the target public transit stop within a given time period, by processing data including the identified population location data using a trained machine learning model; and
providing, to the first user, a notification based on the determined activity data and the location of the first user.

2. The method of claim 1, wherein identifying the population location data includes identifying one or more users having at least one characteristic in common with the first user.

3. The method of claim 2, wherein the at least one characteristic includes geographical area or a common public transit route.

4. The method of claim 1, further comprising:
providing a refund to the first user in response to determining the location of the first user includes the location of the target public transit stop and the activity data associated with the target public transit stop based on the quantity of users entering and leaving the target public transit stop exceeds a predefined threshold.

5. The method of claim 1, wherein the determining activity data associated with the target public transit stop includes processing data collected from a third-party application.

6. The method of claim 5, wherein the data collected from the third-party application includes at least one of a schedule of maintenance, a schedule of delays, a schedule of holidays, or special events.

7. The method of claim 1, wherein the providing, to the first user, the notification based on the determined activity and the location of the first user includes determining satisfaction of a notification trigger.

8. The method of claim 1, wherein the notification based on the determined activity and the location of the first user identifies at least one impact causing delays at the target public transit stop.

9. The method of claim 1, wherein the notification based on the determined activity and the location of the first user identifies at least one alternative transit stop.

10. The method of claim 1, wherein the trained machine learning model is a first trained machine learning model, the method further including determining a pattern of public transportation of the first user via a second trained machine learning model.

11. The method of claim 10, wherein the notification is based on the determined activity, the location of the first user, and the pattern of public transportation of the first user.

12. A computer system for analyzing electronic data associated with a public transit system, comprising:
at least one memory storing instructions; and
at least one processor configured to execute the instructions to perform operations comprising:
determining a location of a target public transit stop of the public transit system;
determining a location of a first user;
retrieving transactional data indicating user transactions at the target public transit stop, the transactional data satisfying one or more criteria for identifying population location data relevant to the target public transit stop;
determining activity data associated with the target public transit stop based on a quantity of users entering and leaving the target public transit stop within a given time period, by processing data including the retrieved transactional data using a trained machine learning model; and
providing to the first user over a computer network, a notification based on the determined activity data and the location of the first user.

13. The system of claim 12, wherein providing the notification includes a monetary refund for entering the target public transmit stop when the location of the first user is the same as the location of the target public transmit stop and the quantity of users entering and leaving the target public transit stop exceed a predefined threshold.

14. The system of claim 12, wherein the determining activity data associated with the target public transit stop includes processing data collected from a third-party application.

15. The system of claim 12, wherein the providing, to the first user, the notification based on the determined activity and the location of the first user includes determining satisfaction of a notification trigger.

16. The system of claim 12, wherein the notification based on the determined activity and the location of the first user identifies at least one impact causing delays at the target public transit stop.

17. The system of claim 12, wherein the notification based on the determined activity and the location of the first user identifies at least one alternative public transit stop.

18. The system of claim 12, wherein the trained machine learning model is a first trained machine learning model, the system further including a second trained machine learning model for collecting data associated with the first user to determine a pattern of public transportation of the first user.

19. The system of claim 18, wherein the notification is based on the determined activity, the location of the first user, and the pattern of public transportation of the first user.

20. A computer system for analyzing electronic data associated with a public transit system, comprising:
at least one memory storing instructions; and
at least one processor configured to execute the instructions to perform operations including:
determining a location of a target public transit stop;
receiving, from a third-party over a computer network, information indicating a disruption at the target public transit stop;
retrieving transactional data indicating user transactions of a first user at the target public transit stop;
identifying a location of the first user based on the transactional data of the first user at the target public transit stop;
determining an activity data of the first user entering and/or leaving the target public transit stop within a given time period, by processing data including the retrieved transactional data using a trained machine learning model; and
providing, to the first user over a computer network, a notification based on the determined activity data and the location of the first user.
